(19) United States
(12) Patent Application Publication
(10) Pub. No.: US 2023/0252495 A1
(43) Pub. Date: Aug. 10, 2023

(54) SYSTEMS AND METHODS TO CHARACTERIZE CONTENT CREATORS WITHIN A MEMBERSHIP PLATFORM

(71) Applicant: Patreon, Inc., San Francisco, CA (US)

(72) Inventors: Maura Church, San Francisco, CA (US); Yacine Brini, San Francisco, CA (US); Carlos Cabrera, San Francisco, CA (US); Matthew Crane, Seattle, WA (US); Manuel Andere, Mexico City (MX)

(21) Appl. No.: 16/821,258

(22) Filed: Mar. 17, 2020

(51) Int. Cl. G06Q 30/02; G06N 20/00; G06F 16/9536; G06Q 10/06

(52) U.S. Cl. CPC G06Q 30/0201; G06N 20/00; G06F 16/9536; G06Q 10/067

(57) ABSTRACT

Systems and methods are provided for characterizing groups of content creators within a membership platform. Exemplary implementations may: identify groups of content creators providing offerings to subscribers within a membership platform; obtain group information, the group information including values of group metrics of individual groups of content creators, the group metrics numerically describing non-monetary characteristics of the individual groups; obtain outcome information, the outcome information conveying monetary characteristics of the individual groups; train a machine learning model on input/output pairs to generate a trained machine learning model; store the trained machine learning model; determine, using the trained machine learning model, one or more group metric profiles that correspond to greater monetization, wherein an individual group metric profile includes a set of one or more values of one or more of the group metrics; and/or perform other operations.

### FIELD

The disclosure relates to systems and methods to characterize content creators within a membership platform.

### BACKGROUND

Different platforms may be utilized by entities seeking contributions from the general public to obtain a needed service(s) and/or resource(s). Some of these platforms facilitate raising resources (i.e., funds) from the users through monetary contributions or donations to support a project. Oftentimes, supporters of a project are given rewards or special perks, where the size and/or exclusivity of the rewards or special perks may depend on the amount contributed.

### SUMMARY

A membership platform may be comprised of users including one or more of content creators, subscribers, and/or other users. Content creators may be users of the membership platform who offer content (also referred to as “benefit items”) to subscribers in exchange for some consideration. A “benefit item” may refer to a good and/or service. A good may comprise a physical good and/or a digital good. In some implementations, subscribers may donate funds to a content creator such that the benefit item may be the altruism in supporting the content creator. Subscribers may be users of the membership platform who subscribe, through payment of a one-time or recurring (e.g., monthly) fee, to one or more content creators. A subscriber of an individual content creator may obtain access to benefit items offered through the membership platform by virtue of being a subscriber to the individual content creator. A subscriber of an individual content creator may obtain preferential access to benefit items offered through the membership platform by virtue of being a subscriber to the individual content creator. Preferential access may refer to subscriber-only access to benefit items and/or other content. Preferential access may refer to tiered levels of access to benefit items and/or other content. Different levels of access may offer different quantities, types, and/or combinations of benefit items. Different levels may correspond to different amounts of consideration paid by the given subscriber. In some implementations, other users of the membership platform may obtain limited access to benefit items. In some implementations, other users may be non-paying users and/or one-time visitors to the membership platform.

Within a membership platform, understanding the metrics of content creators which are indicative of growth of the content creators may be important in order to drive individual creators and/or groups of creators to even greater growth. In some implementations, the metrics considered may include a group size metric, a subscribership size metric, a shared patronage metric, a cross-collaboration metric, a subscriber interaction metric, and/or other metrics. The growth may be measured in terms of monetization conveyed by one or more monetary characteristics. For example, monetary characteristics may include one or more of a total amount of consideration received, an average amount of consideration received, a total amount of consideration received on a per-offering basis, an average amount of consideration received on a per-offering basis, and/or other information. Understanding these metrics and how they apply to growth is even harder when there are thousands, or tens of thousands, of content creators and subscribers to those content creators, such that determining these metrics manually is not possible. One aspect of the present disclosure may utilize one or more techniques that determine the optimal metric(s) of content creators which are indicative of growth. System administrators then may use this information to assist content creators to reach their potential sooner and more effectively.

One aspect of the present disclosure relates to a system configured for characterizing content creators within a membership platform. The system may include one or more hardware processors configured by machine-readable instructions. The computer components may include one or more of a group component, a model training component, a profile component, and/or other computer components.

The group component may be configured to identify one or more groups of subscribers within individual subscriber communities of individual content creators within a membership platform. The group component may be configured to identify groups of content creators within a membership platform providing offerings to the subscribers within the membership platform. The offerings may be for benefit items and/or other content. An individual benefit item may include an original digital good, a physical good, donation, and/or other content.

The group component may be configured to obtain group information and/or other information. The group information may include one or more of values of subscriber group metrics of individual groups of subscribers of individual content creators, values of creator group metrics of individual groups of content creators, and/or other information. The group metrics may numerically describe non-monetary characteristics.

The group component may be configured to obtain outcome information and/or other information. The outcome information may convey monetary characteristics of the individual groups of subscribers of individual content creators and/or monetary characteristics of the individual groups of content creators.

The model training component may be configured to train a machine learning model on input/output pairs to generate a trained machine learning model. The individual input/output pairs may include training input information, training output information, and/or other information for the individual groups. In some implementations, the training input information for an individual input/output pair may include one or more of values of the subscriber group metrics for a given group of subscribers, values of the creator group metrics a given group of content creators, and/or other information. The training output information for the individual input/output pair may include one or more of outcome information for the given group of subscribers and/or outcome information for a given group of content creators, and/or other information. The model training component may be configured to store the trained machine learning model.

The profile component may be configured to determine, using the trained machine learning model, one or more subscriber group metric profiles that correspond to greater monetization and/or other measure of growth. An individual subscriber group metric profile may include a set of one or more values of one or more of the subscriber group metrics. The individual subscriber group metric profiles may convey the subscriber group metrics indicative of greatest monetization and/or other measure of growth.

The profile component may be configured to determine, using the trained machine learning model, one or more creator group metric profiles that correspond to greater monetization and/or other measure of growth. An individual creator group metric profile may include a set of one or more values of one or more of the subscriber group metrics. The individual subscriber group metric profiles may convey the subscriber group metrics indicative of greatest monetization and/or other measure of growth.

As used herein, any association (or relation, or reflection, or indication, or correspondence) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an example membership system.

FIG. 2 illustrates a system configured to characterize content creators within a membership platform, in accordance with one or more implementations.

FIG. 3 illustrates an example database.

FIG. 4 illustrates a method to characterize content creators within a membership platform, in accordance with one or more implementations

### DETAILED DESCRIPTION

Some entities may seek to obtain funds through subscriptions. Such entities may utilize online membership platforms that allow consumers to sign up for ongoing payments in exchange for rewards or other membership benefits.

Entities seeking funding may be content creators, for example, artists, musicians, educators, etc. Content creators may create content, which may refer to one or more of information, experience, products, and/or other content provided to an audience or end-user, whether it be digital, analog, virtual, and/or other form. For example, types of content may include but is not limited to video content, podcasts, photographic art, webcomics, do-it-yourself crafts, digital music, performance art, and/or other types of content. Content creators may utilize membership platforms that allow consumers to become subscribers of the content creator. As subscribers, consumers may contribute or donate money to a content creator on a recurring (e.g., weekly or monthly) basis or per piece of content created by the content creator. Content creators may interact with subscribers and/or prospective subscribers (e.g., consumers that show interest in the content created by content creators) in a variety of ways.

Understanding the metrics of content creators which are indicative of growth of the groups may be important in order to drive the groups to even greater growth. In some implementations, the metrics may include subscriber group metrics describing one or more groups of subscribers to an individual content creator, creator group metrics describing one or more groups of content creators, and/or other metrics. The growth may be measured in terms of monetization as conveyed by one or more monetary characteristics. For example, monetary characteristics may include one or more of a total amount of consideration received, an average amount of consideration received, a total amount of consideration received on a per-offering basis, an average amount of consideration received on a per-offering basis, and/or other information. One aspect of the present disclosure may utilize one or more techniques that determine the optimal metric(s) for growth. System administrators then may use this information to assist content creators and/or groups of content creators to reach their potential sooner and more effectively.

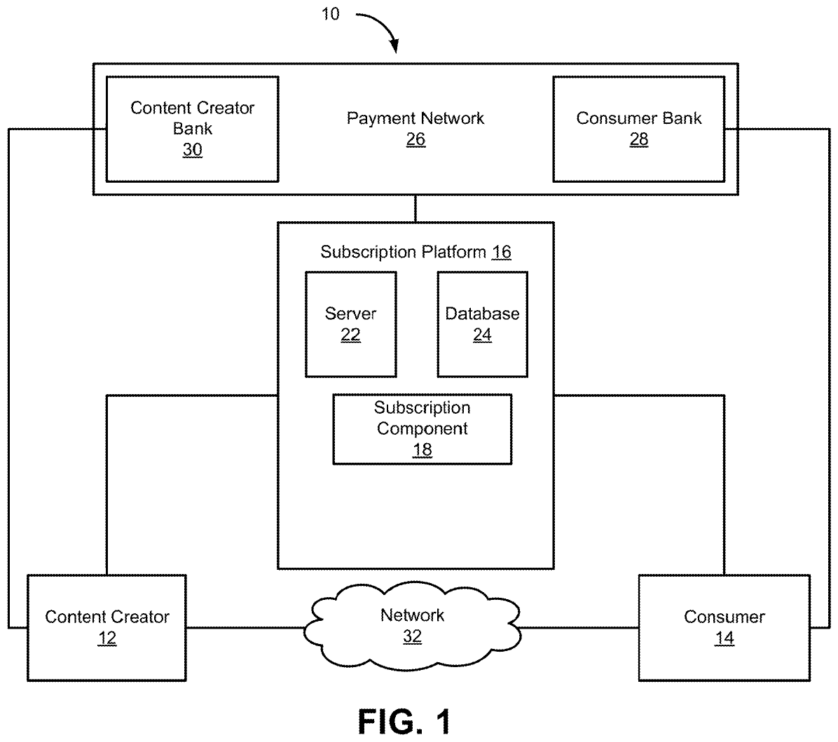

FIG. 1 illustrates an example subscriber-based membership system 10 (sometimes referred to herein as a “membership platform”). A content creator 12 may register and set up a creator account with subscription platform 16. Content creator 12 may create a page on a website hosted by server 22 of subscription platform 16 and input relevant information. Content creator 12 may input information associated with and/or relevant to content creator 12 via subscription component 18, such as creation information, content information, information specifying desired and/or initial subscription levels, preferred revenue source information (e.g., preferred currency, currency source, and/or other information), identification information (e.g., identification of applicable tax jurisdiction and/or other information), and/or other information. A page created by content creator 12 may be built using such information to make potential consumers aware of how content creator 12 may wish to be supported/receive support for his/her content creation in addition to subscribership revenue. Content creator 12 may set up a content creator account with subscription platform 16 through subscription component 18 or another appropriate component allowing content creator 12 to register with subscription platform 16. Various types of information regarding content creator 12 may be input into subscription platform 16, some of which may be information identifying content creator 12.

Consumer 14 (also referred to as a “subscriber”) may set up a subscriber account with subscription platform 16. In setting up the subscriber account, consumer 14 may input demographic information relevant to consumer 14 (e.g., age, income, job, etc.). Information identifying consumer 14 (e.g., name, a picture, a phone number, etc.) may be input by consumer 14 when setting up the subscriber account. Through the page created by content creator 12, a consumer 14 may pledge to donate a given amount of money to content creator 12 every time content creator 12 creates content. For example, if content creator 12 is an artist, consumer 14 may pledge to donate ten dollars each time content creator 12 creates a piece of art.

In order to remit payment to content creator 12, consumer 14 may set up a payment mechanism through subscription platform 16 as part of setting up his/her subscriber account. When subscription platform 16 is notified or determines that content creator 12 has created content, subscription platform 16 may access payment network 26 to obtain and/or transfer the pledged amount from consumer bank 28 to content creator bank 30. Alternatively (or in addition to per content pledge donations), consumer 14 may pledge to donate a given amount to content creator 12 on a recurring basis through subscription platform 16. For example, consumer 14 may pledge to donate five dollars each month to content creator 12, where each month, subscription platform 16 may access payment network 26 to obtain and transfer the pledged amount from consumer bank 28 to content creator bank 30. It should be understood that consumer 14 may have an established relationship with consumer bank 28, and that content creator 12 may have an established relationship with content creator bank 30. It should be noted that subscription platform 16 may retain a portion, such as some percentage, of the pledged amount, as a fee for hosting the page created by content creator 12, providing payment services, etc.

As consideration for the pledged donations, content creator 12 may provide some type of preferential access to consumer 14 in the form of, e.g., special perks or rewards. Content creator 12 may specify tiers of preferential access based upon the amount of money consumer 14 pledges to donate and/or depending on whether the pledged donation is a recurring donation or a per content donation. The amounts and/or types of pledged donations that may be made by consumer 14 to back content creator 12 may be referred to as subscription levels.

For example, in return for a monthly, recurring dollar amount of donation, content creator 12 may provide a high-resolution digital image of the artwork created during that month to consumer 14. In exchange for a weekly, recurring dollar amount of donation, content creator 12 may provide a high-resolution digital image of the artwork created during that month as well as a time-lapse video of content creator 12 creating the artwork. In exchange for another dollar amount per content donation, content creator 12 may provide a low-resolution digital image of the artwork. For another dollar amount per content donation, content creator 12 may engage in a live webchat or live meet-and-greet with consumer 14. Various types of preferential access may be provided by content creator 12 to consumer 14, and content creator 12 may specify the subscription level to preferential access correlation.

The preferential access may be provided to consumer 14 from content creator 12. For example, content creator 12 may email digital copies of artwork to consumer 14 over a communications network, such as a local area network (LAN), a wide area network (WAN), a wireless network (e.g., WiFi), a mobile communication network, a satellite network, the Internet, fiber optic, coaxial cable, infrared, radio frequency (RF) or any other suitable network. The preferential access may be provided to consumer 14 from content creator 12 via subscriber platform 16. For example, the live webchat between content creator 12 and consumer 14 may be provided through some chat functionality of the page of content creator 12 hosted on server 22 of subscription platform 16, which may reside on communications network 32 or on another network (not shown).

It should be noted that not all subscription levels are necessarily associated with preferential access. Some consumers may be driven to subscribe to content creator 12 on the basis of created content rather than any special perks or rewards.

The specification and management of subscriptions on behalf of content creator 12 may be handled by subscription component 18 alone or in conjunction with database 24. For example, a user interface may be provided via subscription component 18 allowing content creator 12 to specify his/her desired subscription levels and corresponding preferential access, as well as his/her preferred sources of revenue. Subscription component 18 may receive the information input by content creator 12 and transmit the information for storage as one or more records, matrices, or other data structures in database 24 or within memory local to subscription component 18. Database 24 or the local memory of subscription component 18 may be configured in a suitable database configuration; such as a relational database, a structured query language (SQL) database, a distributed database, an object database, etc. Suitable configurations and database storage types will be apparent to persons having skill in the relevant art.

Content creator 12 may add subscribership information, update and/or delete existing subscribership information, add creation information, as well as update and/or delete creation information, add, update, and/or delete preferential access information and/or its correspondence to subscription levels, etc. Such changes may be input via subscription component 18 and reflected in its local memory and/or database 24. It should be understood that content creator 12 and/or consumer 14 may be an individual or some entity representative of an individual or group of individuals.

Apart from providing preferential access to consumer 14, content creator may engage with consumer 14 by interacting in a variety of ways. For example, content creator 12 may communicate with consumer 14 over email, one or more social media platforms, a messaging platform or other appropriate communication mechanism or method. It should be understood that such communication platforms or mechanisms may be embodied in communications network 32 allowing content creator 12 and consumer 14 to communicate outside of subscription platform 16. It should be understood that communication platforms or mechanisms may operate in conjunction with subscription platform 16 such that one or more of their respective functionalities may be utilized through subscription platform 16. For example, social media hyperlinks allowing information from content creator 12's page may be provided on the webpage allowing content creator 12 to share content creation progress updates with consumer 14. For example, content creator 12 may respond to a communication from consumer 14 posted on a comment section provided on content creator 12's page in a private message or as part of the comment thread. It should be noted that content creator 12 may engage a single consumer, e.g., consumer 14, one-on-one and/or may engage a group of consumers. For example, content creator 12 may post a “public” comment on his/her webpage that may be seen by any consumer that is a subscriber to content creator 12 and/or any consumer that may be a potential subscriber.

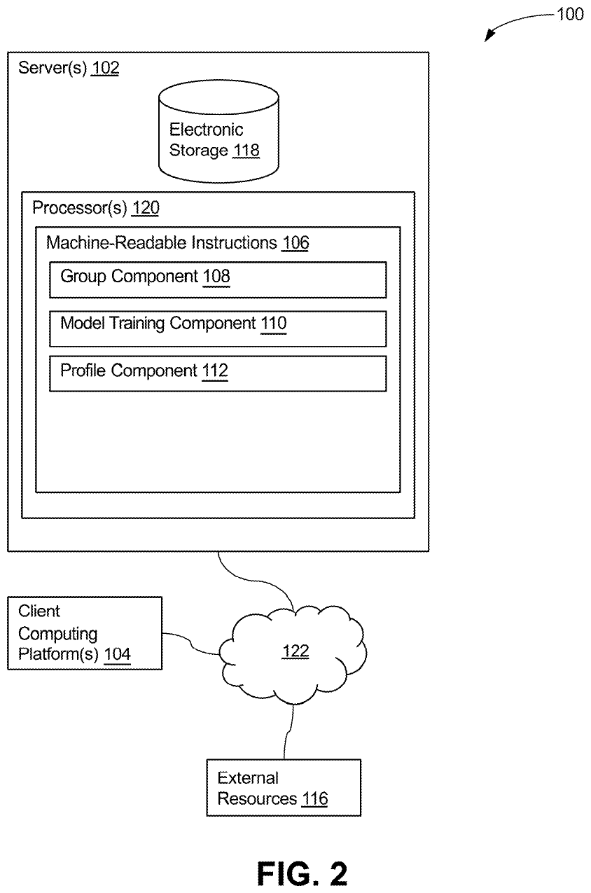

FIG. 2 illustrates a system 100 configured to characterize content creators within a membership platform. In some implementations, system 100 may include one or more of server(s) 102, client computing platform(s) 104, and/or other components. Server(s) 102 may be configured to communicate with one or more client computing platforms 104 according to a client/server architecture and/or other architectures via one or more network(s) 122. The terms client computing platform, remote computing platform, and/or computing platform may be used interchangeably herein to refer to individual ones of the client computing platform(s) 104. In some implementations, one or more network(s) 122 may include the Internet and/or other networks. Client computing platform(s) 104 may be configured to communicate with other client computing platforms via server(s) 102 and/or according to a peer-to-peer architecture, a client-server architecture, and/or other architectures. Users may access system 100 via client computing platform(s) 104.

It is noted the system 100 of FIG. 2 may be the same as, or included as part of, the system 10 shown in FIG. 1. For example, the server(s) 102 may be the same as or included in servers 22. Network(s) 122 may be the same as or included in network 32. Individual client computing platforms of one or more client computing platforms 104 may be computing platforms utilized by content creator 12 and/or consumer 14 to access system 10 and/or system 100. Non-transitory electronic storage 118 may be the same as or included in database 24. Accordingly, those skilled in the art will recognize that although system 10 and system 100 are shown and described separately, they may comprise a single common system. However, in some implementations, the features and/or functionality of system 100 may be provided remotely as a separate system from system 10.

Server(s) 102 may be configured by machine-readable instructions 106. Machine-readable instructions 106 may include one or more instruction components. The instruction components may include computer program components. The instruction components may include one or more of a group component 108, a model training component 110, a profile component 112, and/or other instruction components.

Group component 108 may be configured to identify one or more groups of subscribers within individual communities of individual content creators within a membership platform. The subscribers to a content creator may be referred to as the content creator's community. The one or more groups may be identified within that community. The individual groups may be referred to as sub-communities.

The group component 108 may be configured to identify groups of content creators within a membership platform providing offerings to the subscribers within the membership platform. The offerings may be for benefit items and/or other content. An individual benefit item may include an original digital good, a physical good, donation, and/or other content.

In some implementations, group component 108 may be configured to identify groups of subscribers and/or groups of content creators using a clustering algorithm and/or other techniques. In some implementations, the clustering algorithm may be a Louvain community detection algorithm and/or other algorithm.

In some implementations, the context in which subscribers within a community may be grouped may be based on one or more of geographic location (e.g., content creators within a common geographic location), interaction (e.g., subscribers who interact with each other, for example, through comments, chat, message boards, and/or other technique), common interest in type of benefit items (e.g., subscribers who commonly subscribe to content creators who create content of the same or similar type), and/or other characteristics.

In some implementations, the context in which content creators may be grouped may be based on one or more of geographic location (e.g., content creators within a common geographic location), subject matter of benefit items (e.g., content creators creating content of the same or similar subject matter), type of benefit items (e.g., content creators creating content of the same or similar type), and/or other characteristics.

Group component 108 may be configured to obtain group information and/or other information. The group information may include one or more of values of subscriber group metrics describing individual groups of subscribers of individual content creators, values of creator group metrics describing individual groups of content creators, and/or other information. The group metrics may numerically describe non-monetary characteristics. Subscriber group metrics may include a group size metric, a subscribership metric, and/or other metrics. Creator group metrics may include group size metric, a subscribership metric, a cross-collaboration metric, a subscriber interaction metric, and/or other metrics. The group component 108 may obtain the group information by determining and/or deriving the group information for individual content creators and/or individual groups of content creators.

A value of a group size metric of an individual group of subscribers may describe a quantity of subscribers within the individual group. A value of a group size metric may describe a quantity of subscribers within an individual group over a certain period of time. A quantity of subscribers within an individual group may include an average (or other calculation) quantity computed over a certain period of time. A quantity of subscribers within an individual group may include a quantity determined at a given point in time.

A value of a subscribership size metric of an individual group of subscribers may describe subscriptions that the individual subscribers within the individual group currently hold. The value of a subscribership size metric of an individual group of subscribers may describe a quantity of subscriptions of the individual subscribers within the individual group. In some implementations, a value of a subscribership size metric may describe a mean, median, and/or mode of the quantity of subscriptions for an individual subscriber in the individual group. In some implementations, a value of a subscribership size metric may describe a highest quantity of subscriptions by one or more of subscribers in an individual group. In some implementations, a value of a subscribership size metric may describe a lowest quantity of subscriptions by one or more subscribers in an individual group. In some implementations, a value of a subscribership size metric of an individual group of subscribers may describe a quantity of subscribers commonly subscribing to “N” quantity of content creators in the individual group. “N” may be a number greater than 1.

A value of a group size metric of an individual group of content creators may describe a quantity of content creators within the individual group. A value of a group size metric may describe a quantity of content creators within an individual group over a certain period of time. A quantity of content creators within an individual group may include an average (or other calculation) quantity computed over a certain period of time. A quantity of content creators within an individual group may include a quantity determined at a given point in time.

A value of a subscribership size metric of an individual group of content creators may describe a quantity of subscribers subscribing to the content creators in the individual group. The value of the subscribership size metric may describe the collective quantity of subscribers for the individual group. In some implementations, a value of a subscribership size metric may describe a mean, median, and/or mode of the collective quantity of subscribers for the individual group. In some implementations, a value of a subscribership size metric may describe a highest quantity of subscribers subscribing to an individual content creator in an individual group. In some implementations, a value of a subscribership size metric may describe a lowest quantity of subscribers subscribing to an individual content creator in an individual group.

A value of a shared patronage metric of an individual group of content creators may describe a quantity of individual subscribers commonly subscribing to “N” quantity of content creators in the individual group. “N” may be a number greater than 1, and up to the quantity of content creators within an individual group.

A value of a cross-collaboration metric of an individual group of content creators may describe content creators within the individual group who collaborate together to make benefit items. A value of a cross-collaboration metric may describe a quantity of content creators within an individual group who collaborate together to make benefit items. Collaboration may include cooperatively participating in planning, making, using, displaying, distributing, advertising, and/or performing the benefit item. A value of a cross-collaboration metric may describe a quantity of benefit items associated with two or more collaborating content creators. A value of a cross-collaboration metric may describe a length of time two or more content creators within an individual group collaborated.

A value of a subscriber interaction metric of an individual group of content creators may describe content creators within the individual group who interact with one or more of their own subscribers. A value of a subscriber interaction metric may describe a quantity of content creators within an individual group who interact with one or more of their subscribers. A value of a subscriber interaction metric may describe a quantity of content creators within an individual group who interact with one or more of their subscribers a given quantity of times. A value of a subscriber interaction metric may describe a quantity of content creators within an individual group who interact with one or more of their subscribers over a given period of time. A value of a subscriber interaction metric may describe a frequency at which individual content creators in an individual group interact with one or more of their subscribers. A value of a subscriber interaction metric may describe an average or aggregate frequency at which the content creators of an individual group as a whole interact with one or more of their subscribers. A value of a subscriber interaction metric may describe a quantity of content creators within an individual group who interact with “M” quantity of subscribers. “M” may be a number greater than 1. A value of a subscriber interaction metric may describe a quantity of content creators within an individual group who interact with “X” percent of subscribers. “X” may be a number between 1 and 100.

Group component 108 may be configured to obtain outcome information and/or other information. The outcome information may convey one or more of the individual groups of subscribers of individual content creators, monetary characteristics of the individual groups of content creators, and/or other information. The monetary characteristics may describe the action(s) and/or process(s) which lead to revenue generation.

The monetary characteristics of the individual groups of subscribers may include one or more of a total amount of consideration received from individual groups of subscribers, an average amount of consideration received from individual groups of subscribers, a total amount of consideration received from individual subscribers, an average amount of consideration received from individual subscribers, a total amount of consideration received from individual groups of subscribers on a per-offering basis, an average amount of consideration received from individual groups of subscribers on a per-offering basis, total amount of consideration received from individual subscribers on a per-offering basis, an average amount of consideration received from individual subscribers on a per offering basis, and/or other characteristics.

The monetary characteristics of the individual groups of content creators may include one or more of a total amount of consideration received from a community of subscribers, (e.g., funds received in exchange for benefit items, donation, etc.), an average amount of consideration received from a community of subscribers, a total amount of consideration received from a group of subscribers, an average amount of consideration received from a group of subscribers, a total and/or average amount of consideration received on a per-subscriber basis (for subscribers that subscribe to more than one creator in a group), a total amount of consideration received on a per-offering basis, an average amount of consideration received on a per-offering basis, and/or other monetary characteristics.

Group component 108 may obtain the outcome information by determining and/or deriving the outcome information. The amounts of consideration may be based on an individual currency. Consideration received in a given currency may be converted to another currency based on one or more exchange rates.

Model training component 110 may be configured to train a machine learning model on input/output pairs to generate a trained machine learning model. The individual input/output pairs may include training input information and training output information for the individual groups. The training input information for an individual input/output pair may include one or more of values of the subscriber group metrics, values of creator group metrics, and/or other information. The training output information for the individual input/output pair may include the outcome information for an individual group of subscribers and/or individual group of content creators. Model training component 110 may be configured to store the trained machine learning model.

The machine learning model may include one or more of a neural network, a convolutional neural network, and/or other machine-learning framework. In some implementations, the machine learning model may be configured to optimize objective functions. In some implementations, optimizing objective functions may include one or both of maximizing a likelihood of the training set or minimizing a classification error on a held-out set.

Profile component 112 may be configured to determine, using the trained machine learning model, one or more subscriber group metric profiles that correspond to greater (and/or greatest) monetization (e.g., relative to other groups). In some implementations, monetization may refer to one or more of the monetary characteristics and/or other measures. An individual subscriber group metric profile may include a set of one or more values of one or more of the subscriber group metrics. By way of non-limiting illustration, the trained machine learning model may be used to determine a first subscriber group metric profile corresponding to the greatest monetization within community of subscribers of an individual creator. The first subscriber group metric profile may include a value of the subscriber group size metric and/or other values of other group metrics. In some implementations, the value may be an “optimal” size of a group of subscribers where growth for a given content creator is at its highest.

Profile component 112 may be configured to determine, using the trained machine learning model, one or more creator group metric profiles that correspond to greater (and/or greatest) monetization (e.g., relative to other groups). In some implementations, monetization may refer to one or more of the monetary characteristics and/or other measures. An individual creator group metric profile may include a set of one or more values of one or more of the creator group metrics. By way of non-limiting illustration, the trained machine learning model may be used to determine a first creator group metric profile corresponding to the greatest monetization within a set of groups of content creators. The first creator group metric profile may include a first value of the creator group size metric and/or other values of other group metrics. In some implementations, the first value may be an “optimal” size of a group of content creators where growth is at its highest.

In some implementations, profile component 112 may be configured to use the trained machine learning model to determine one or more recommendations for changing one or more of the values of the subscriber group metrics for an individual group of subscribers. Changing the one or more of the values of the subscriber group metrics for the individual group may cause (and/or illicit) an individual content creator to achieve greater monetization. The recommendations may identify the groups who do not currently meet the recommended values of the subscriber group metrics. By way of non-limiting illustration, the trained machine learning model may be configured to output a recommendation including changing a value of the subscriber group size metric within a content creators community to the optimal size.

In some implementations, profile component 112 may be configured to use the trained machine learning model to determine one or more recommendations for changing one or more of the values of the creator group metrics for an individual group of content creators. Changing the one or more of the values of the creator group metrics for the individual group may cause (and/or illicit) the individual group to achieve greater monetization. The recommendations may identify the groups who do not currently meet the recommended values of the creator group metrics. By way of non-limiting illustration, the trained machine learning model may be configured to output a first recommendation including changing a value of the creator group size metric for one or more groups to the first value.

In some implementations, profile component 112 may be configured to provide the trained machine learning model with one or more of a set of values of the subscriber group metrics for a given group of subscribers, desired outcome information conveying desired monetary characteristics of given group, and/or other information. The trained machine learning model may be configured to output, based on the provided information, recommendations for changing one or more of the values of the subscriber group metrics for the given group so that the given group achieves (and/or approaches) the desired monetary characteristics. By way of non-limiting illustration, the profile component 112 may be configured to provide the trained machine learning model with one or more of a set of values of the subscriber group metrics for a group, desired outcome information conveying desired monetary characteristics of the group, and/or other information. The profile component 112 may use the trained machine learning model to output recommendations for changing one or more of the values of the subscriber group metrics for the group so that the group achieves (and/or approaches) the desired monetary characteristics.

In some implementations, profile component 112 may be configured to provide the trained machine learning model with one or more of a set of values of the creator group metrics for a given group of content creators, desired outcome information conveying desired monetary characteristics of the given group, and/or other information. The trained machine learning model may be configured to output, based on the provided information, recommendations for changing one or more of the values of the creator group metrics for the given group so that the given group achieves (and/or approaches) the desired monetary characteristics. By way of non-limiting illustration, the profile component 112 may be configured to provide the trained machine learning model with one or more of a set of values of the creator group metrics for a first group, first desired outcome information conveying desired monetary characteristics of the first group, and/or other information. The profile component 112 may use the trained machine learning model to output recommendations for changing one or more of the values of the creator group metrics for the first group so that the first group achieves (and/or approaches) the desired monetary characteristics.

In some implementations, the profile component 112 may be configured to effectuate presentation of one or more recommendations, one or more subscriber group metric profiles, one or more creator group metric profiles, and/or other information on a user interface displayed on individual ones of the client computing platform(s) 104. The recommendations may be presented to system administrators so that they can take next step actions. The next step actions may include, for example, reaching out to content creators in and/or providing suggestions in line with the recommendations. In some implementations, the recommendations may be presented to content creators. A recommendation for an individual creator may include, for example, “If you are a creator making X, and you achieve Y number of subscribers, you will have better growth.” A recommendation for creators in a group of content creators may include, for example, “If your group adds 10 more creators, you will have an optimal number of creators in your group!.” Recommendations may include other information and/or may be generated in other ways. A subscriber group metric profile may describe, for example, “creators who have at least one sub community that interacts with each other at least once a week generates the most revenue.” A creator group metric profile may describe, for example, “groups of 100 content creators generate the most revenue.” A profile may be presented in the form of a chart, a table, and/or other presentation techniques to convey one or more values of one or more of the creator and/or subscriber group metrics.

In some implementations, server(s) 102, client computing platform(s) 104, and/or external resources 116 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 116 may be operatively linked via some other communication media.

A given client computing platform 104 may include one or more processors configured to execute one or more computer program components. The computer program components may be configured to enable an expert or user associated with the given client computing platform 104 to interface with system 100, system 10, and/or external resources 116, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 116 may include sources of information outside of system 100, external entities participating with system 100, and/or other resources. In some implementations, some or all of the functionality attributed herein to external resources 116 may be provided by resources included in system 100.

Server(s) 102 may include electronic storage 118, one or more processors 120, and/or other components. Server(s) 102 may include communication lines, or ports to enable the exchange of information with a network and/or other computing platforms. Illustration of server(s) 102 in FIG. 2 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably communicable with server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from client computing platform(s) 104, and/or other information that enables server(s) 102 to function as described herein.

Processor(s) 120 may be configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 2 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute components 108, 110, and/or 112, and/or other components. Processor(s) 120 may be configured to execute components 108, 110, and/or 112, and/or other components by software; hardware; firmware; some combination of software, hardware, and/or firmware; and/or other mechanisms for configuring processing capabilities on processor(s) 120. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 2 as being implemented within a single processing unit, in implementations in which processor(s) 120 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 120 may be configured to execute one or more additional components that may perform some or all of the functionality attributed below to one of components 108, 110, and/or 112.

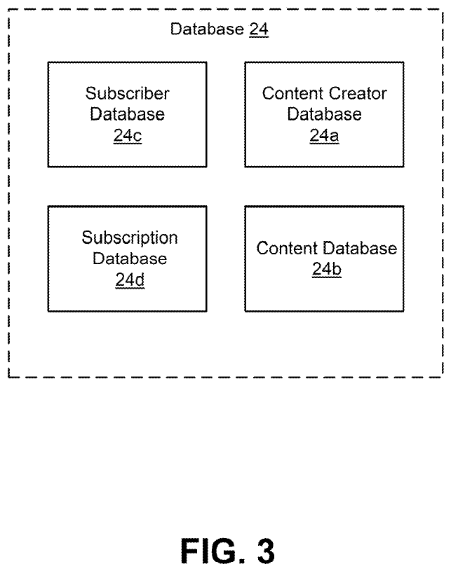

FIG. 3 illustrates elements that may make up database 24. As indicated previously, subscription component 18 of FIG. 1 may transmit information input by content creator 12 and/or consumer 14 regarding creation and/or subscribership information to database 24. Subscription platform 16, via server 22, for example, may monitor and obtain creation and/or subscribership information for storage in database 24. For example, subscription platform 16 may monitor and store additional content creator and/or subscriber demographic information as well as performance-related subscribership information, e.g., engagement activity between content creator 12 and his/her subscribers, one of whom may be consumer 14. For example, subscription platform 16 may monitor the amount of money being generated and/or lost through the subscribers (e.g., outcome information), as well as content creator 12's subscriber retention rate. For example, subscription platform 16 may monitor and store performance-related creation information, such as the amount of content that content creator 12 is creating, how often and/or how quickly content creator 12 reacts to subscriber engagement activity, etc.

Database 24 may include one or more databases or partitions in which information relating to content creator 12, and/or subscribership relevant to content creator 12. For example, database 24 may include a content creator database 24a, a content database 24b, a subscriber database 24c, and a subscription database 24d. It should be noted that the elements and/or functionality of database 24 may be implemented in local memory resident in subscription component 18 or shared between database 24 and the local memory of subscription component 18 rather than solely in database 24.

Database 24 may be populated with group information, outcome information, creation data and/or subscription level information monitored or obtained from and/or associated with existing content creator and/or subscriber accounts established in subscription platform 16, and/or other information. Creation data may refer to information that characterizes one or more of content creator 12, the content that content creator 12 creates, and activity engaged in by content creator 12 to interact with one or more subscribers and/or to which consumer 14 is granted preferential access.

Content creator information characterizing content creator 12 may be information reflecting the type of creator that content creator 12 designates him/herself to be and/or any preferences regarding subscription offerings by content creator 12. For example, content creator type information may reflect that content creator 12 may be a paint artist, a digital artist, a sculptor, a video game developer, a writer, a performance artist, etc. Content creator preference information may reflect subscription levels content creator 12 wishes to offer to subscribers. Content creator preference information may reflect, e.g., a desired minimum revenue, preferred sources of revenue, subscription level proportions, etc. For example, content creator preference information may include information indicating content creator 12's desire for more subscribers pledging some amount of money or less subscribers pledging a greater amount of money. For example, content creator preference information may include information specifying that content creator 12 wishes to supplement his/her subscription-generated revenue with revenue generated from the sale of promotional merchandise. Such information may be stored in a content creator database 24a.

In addition to content creation-related information, and upon registering with subscription platform 16 as a content creator, content creator 12 may input information characterizing the identity of content creator 12. For example, content creator 12 may input or upload contact information, a telephone number associated with a personal user device, such as smartphone, an email address, a photograph, and/or other identifying information. Such identifying information may be used by subscription platform 16 in a variety of ways to associate content creator 12 with particular content, his/her webpage, payment of subscription donations, and/or other information.

Content information characterizing the content that content creator 12 creates may refer to one or more of the type of content created, the medium in which the content is created and/or presented, the amount of content created, and/or the frequency at which the content is created. For example, type of content information and/or content medium information may indicate that content creator 12 creates paintings on canvas, develops video games for a mobile platform, performs in online musical performances, and/or other information. For example, content amount information may reflect that content creator 12 created a series of artwork comprising four paintings. For example, content frequency information may indicate that content creator 12 developed three video games over the course of six months. Such information may be stored in content database 24b.

Consumer 14 may subscribe to content creator 12 by registering with subscription platform 16. During registration, consumer 14 may input certain subscriber demographic information indicative of economic and/or social characteristics of consumer 14. Subscriber demographic information may reflect the yearly income of consumer 14, a geographic area in which consumer 14 resides, the age of consumer 14, interests of consumer 14, etc. Subscriber information may include data regarding the amount of money consumer 14 is currently pledged to donate to one or more content creators. Over time, as monitored and collected by subscription platform 16, subscriber information may include information regarding the amount of money consumer 14 has previously donated to one or more content creators, including content creator 12. Subscriber information, as monitored and obtained by subscription platform 16 may include an Internet Protocol (IP) address indicative of a current location of consumer 14 and/or an IP address indicating a payment source. Such information may be stored in subscriber database 24c.

Like content creator 12, consumer 14 may input or upload other identifying information that may be used by subscription platform 16 in a variety of ways to associate consumer 14 with particular content, a particular content creator, payment of subscription donations, etc. For example, a photograph or phone number of consumer 14 may be used, e.g., as a mechanism for correlating consumer 14's attendance at a live event with consumer 14's status as a subscriber of content creator 12, another content creator present at the live event, a subscriber of content similar to that being presented at the live event, etc. Such information may be stored in subscriber database 24c. Subscription component 18 or another component may be used to provide a user interface that may be used by consumer 14 to input such information.

Subscription level information may refer to information characterizing different subscription levels and corresponding preferential access information specified by content creator 12. For example, subscription level information may reflect that a ten dollar recurring donation is rewarded with a high-resolution digital image of artwork created during that month to consumer 14. Such subscriber level information may be stored in subscription database 24d.

It should be noted that other databases or partitions may make up database 24. For example, database 24 may include one or more databases or partitions for storing information including, but not limited to the following: preferential access information characterizing activity in which content creator 12 engagements may refer to data reflecting the type of activity, the level and/or exclusivity of preferential access to that activity granted to consumer 14; subscriber and/or content creator engagement information characterizing interactions, the type and/or frequency of interactions between subscribers and content creators, and/or the medium over which interactions may occur; and historical subscription level and/or engagement information reflecting subscription level and/or engagement information monitored and gathered over one or more periods of time.

It should be noted that some of the information described above may not necessarily be required. It should be noted that information reflecting additional aspects of, e.g., the content, content creator, content creator preferences, and/or subscribership is contemplated by the disclosure. For example, preferential access need not necessarily be offered for each subscription level. For example, subscriber data may include data reflecting particular content creators to which a subscriber pledges donations.

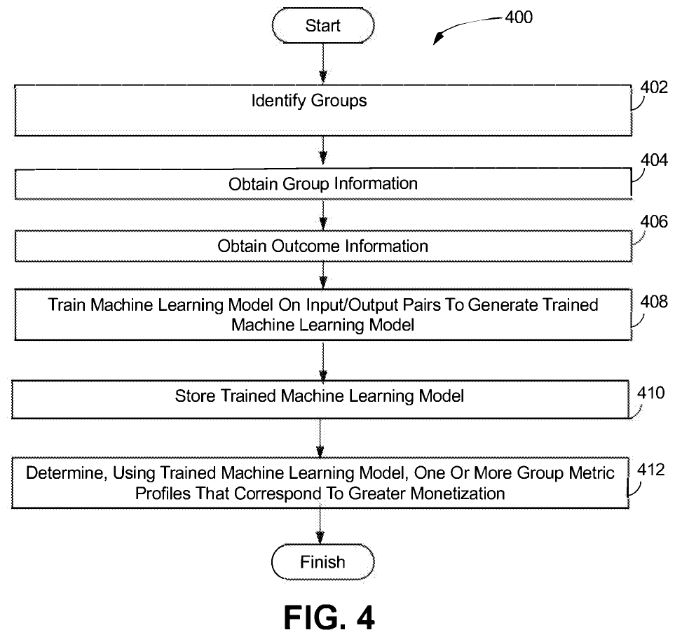

FIG. 4 illustrates a method 400 to characterize content creators within a membership platform, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include identifying groups of subscribers and/or content creators providing offerings to subscribers within a membership platform. Operation 402 may be performed by one or more hardware processors configured by machine-readable instructions including a component that is the same as or similar to group component 108, in accordance with one or more implementations.

An operation 404 may include obtaining group information and/or other information. Operation 404 may be performed by one or more hardware processors configured by machine-readable instructions including a component that is the same as or similar to group component 108, in accordance with one or more implementations.

An operation 406 may include obtaining outcome information and/or other information. Operation 406 may be performed by one or more hardware processors configured by machine-readable instructions including a component that is the same as or similar to group component 108, in accordance with one or more implementations.

An operation 408 may include training a machine learning model on input/output pairs to generate a trained machine learning model. Operation 408 may be performed by one or more hardware processors configured by machine-readable instructions including a component that is the same as or similar to model training component 110, in accordance with one or more implementations.

An operation 410 may include storing the trained machine learning model. Operation 410 may be performed by one or more hardware processors configured by machine-readable instructions including a component that is the same as or similar to model training component 110, in accordance with one or more implementations.

An operation 412 may include determining, using the trained machine learning model, one or more creator and/or subscriber group metric profiles that correspond to greater monetization. Operation 412 may be performed by one or more hardware processors configured by machine-readable instructions including a component that is the same as or similar to profile component 112, in accordance with one or more implementations.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system configured to characterize groups of content creators within a membership platform, the system comprising:
one or more physical processors configured by machine-readable instructions to:
identify, by a server, groups of content creators providing offerings to subscribers within a membership platform, the content creators accessing the membership platform through remotely located client computing platforms communicating with the server over one or more Internet connections, the offerings including subscribership to the content creators in exchange for recurring consideration paid to the content creators, the subscribers receiving benefit items from the content creators as part of the subscribership to the content creators, the content creators being grouped based on one or more of common geographic location, being creators of a common subject matter of the benefit items, or being creators of a common type of the benefit items;
obtain, by the server, group metric information characterizing individual ones of the groups of the content creators, the group metric information including values of group metrics of the individual ones of the groups of the content creators, the group metrics numerically describing non-monetary characteristics of the individual ones of the groups, the group metrics including a group size metric describing a quantity of the content creators within the individual ones of the groups;
obtain, by the server, outcome information characterizing the individual ones of the groups of the content creators, the outcome information conveying monetary characteristics of the individual ones of the groups based on acceptance of the offerings by the subscribers;
train, by the server, a machine learning model on input/output pairs to generate a trained machine learning model, the input/output pairs including training input information and training output information for the individual ones of the groups, the training input information for an input/output pair including the values of the group metrics for a given group, and the training output information for the input/output pair including the outcome information for the given group;
store the trained machine learning model within non-transitory electronic storage;
cause, by the server, the trained machine learning model to output one or more group metric profiles of the groups of the content creators that correspond to greater monetization by the content creators within the individual ones of the groups by virtue of greater acceptance of the offerings by the subscribers, wherein an individual group metric profile includes a set of one or more of the values of one or more of the group metrics that correspond to the greater monetization by the content creators within the individual ones of the groups, such that the trained machine learning model is caused to output a first group metric profile including a first value of the group size metric corresponding to the greater monetization by the content creators within the individual ones of the groups, the first value conveying a most advantageous quantity of the content creators that should be included in an individual group in order to achieve the greater monetization by virtue of the greater acceptance of the offerings by the subscribers;
establish the one or more Internet connections between the remotely located client computing platforms and the server;
generate, by the server, user interface information defining a user interface of the membership platform, the user interface displaying one or more group metric profiles that correspond to the greater monetization; and
effectuate communication of the user interface information from the server to the remotely located client computing platforms over the one or more Internet connections to cause the remotely located client computing platforms to present the user interface, such that the user interface information is communicated from the server to a first remotely located client computing platform associated with a first content creator over a first Internet connection to cause the first remotely located client computing platform to present the first group metric profile displayed within the user interface.

2. The system of claim 1, wherein the one or more physical processors are further configured by the machine-readable instructions to:
cause the trained machine learning model to further output one or more recommendations for changing one or more of the values of the group metrics for the individual ones of the groups so that the individual ones of the groups achieves the greater monetization, such that a first recommendation for one or more of the groups includes changing a value of the group size metric to the first value.

3. The system of claim 1, wherein the one or more physical processors are further configured by the machine-readable instructions to:
provide the trained machine learning model a set of values of the group metrics for a first group and the outcome information conveying desired monetary characteristics of the first group; and
configure the trained machine learning model to further output recommendations for changing one or more of the values of the group metrics for the first group so that the first group achieves the desired monetary characteristics.

4. The system of claim 1, wherein the group metrics further include one or more of a subscribership size metric, a shared patronage metric, a cross-collaboration metric, or a subscriber interaction metric.

5. The system of claim 1, wherein the monetary characteristics of the individual ones of the groups include one or more of a total amount of consideration received, an average amount of consideration received, a total amount of consideration received on a per-offering basis, or an average amount of consideration received on a per-offering basis.

6. The system of claim 1, wherein the groups of the content creators are identified using a clustering algorithm.

7. The system of claim 6, wherein the clustering algorithm is a Louvain community detection algorithm.

8. The system of claim 1, wherein an individual benefit item includes an original digital good, a physical good, or donation.

9. (canceled)

10. The system of claim 1, wherein a value of the group size metric describes one or more of a quantity of the content creators determined at a given point in time, a quantity of the content creators over a certain period of time, or an average quantity of the content creators computed over the certain period of time.

11. A method to characterize groups of content creators within a membership platform, the method comprising:
Identifying, by a server, groups of content creators providing offerings to subscribers within a membership platform, the content creators accessing the membership platform through remotely located client computing platforms communicating with the server over one or more Internet connections, the offerings including subscribership to the content creators in exchange for recurring consideration paid to the content creators, the subscribers receiving benefit items from the content creators as part of the subscribership to the content creators, the content creators being grouped based on one or more of common geographic location, being creators of a common subject matter of the benefit items, or being creators of a common type of the benefit items;
obtaining, by the server, group metric information characterizing individual ones of the groups of the content creators, the group metric information including values of group metrics of the individual ones of the groups of the content creators, the group metrics numerically describing non-monetary characteristics of the individual ones of the groups, the group metrics including a group size metric describing a quantity of the content creators within the individual ones of the groups;
obtaining, by the server, outcome information characterizing the individual ones of the groups of the content creators, the outcome information conveying monetary characteristics of the individual ones of the groups based on acceptance of the offerings by the subscribers;
training, by the server, a machine learning model on input/output pairs to generate a trained machine learning model, the input/output pairs including training input information and training output information for the individual ones of the groups, the training input information for an input/output pair including the values of the group metrics for a given group, and the training output information for the input/output pair including the outcome information for the given group;
storing the trained machine learning model within non-transitory electronic storage;
causing, by the server, the trained machine learning model to output one or more group metric profiles of the groups of the content creators that correspond to greater monetization by the content creators within the individual ones of the groups by virtue of greater acceptance of the offerings by the subscribers, wherein an individual group metric profile includes a set of one or more of the values of one or more of the group metrics that correspond to the greater monetization by the content creators within the individual ones of the groups, including causing the trained machine learning model to output a first group metric profile including a first value of the group size metric corresponding to the greater monetization by the content creators within the individual ones of the groups, the first value conveying a most advantageous quantity of the content creators that should be included in an individual group in order to achieve the greater monetization by virtue of the greater acceptance of the offerings by the subscribers;
establishing the one or more Internet connections between the remotely located client computing platforms and the server;
generating, by the server, user interface information defining a user interface of the membership platform, the user interface displaying one or more group metric profiles that correspond to the greater monetization; and
effectuating communication of the user interface information from the server to the remotely located client computing platforms over the one or more Internet connections to cause the remotely located client computing platforms to present the user interface, including effectuating communication of the user interface information from the server to a first remotely located client computing platform associated with a first content creator over a first Internet connection to cause the first remotely located client computing platform to present the first group metric profile.

12. The method of claim 11, further comprising:
causing the trained machine learning model to further output one or more recommendations for changing one or more of the values of the group metrics for the individual ones of the groups so that the individual ones of the groups achieves the greater monetization, such that a first recommendation for one or more of the groups includes changing a value of the group size metric to the first value.

13. The method of claim 11, further comprising:
providing the trained machine learning model a set of values of the group metrics for a first group and the outcome information conveying desired monetary characteristics of the first group; and
configuring the trained machine learning model to further output recommendations for changing one or more of the values of the group metrics for the first group so that the first group achieves the desired monetary characteristics.

14. The method of claim 11, wherein the group metrics further include one or more of a subscribership size metric, a shared patronage metric, a cross-collaboration metric, or a subscriber interaction metric.

15. The method of claim 11, wherein the monetary characteristics of the individual ones of the groups include one or more of a total amount of consideration received, an average amount of consideration received, a total amount of consideration received on a per-offering basis, or an average amount of consideration received on a per-offering basis.

16. The method of claim 11, wherein the groups of the content creators are identified using a clustering algorithm.

17. The method of claim 16, wherein the clustering algorithm is a Louvain community detection algorithm.

18. The method of claim 11, wherein an individual benefit item includes an original digital good, a physical good, or donation.

19. (canceled)

20. The method of claim 11, wherein a value of the group size metric describes one or more of a quantity of the content creators determined at a given point in time, a quantity of the content creators over a certain period of time, or an average quantity of the content creators computed over the certain period of time.
